(19) United States
(12) Patent Application Publication
(10) Pub. No.: US 2010/0321413 A1
(43) Pub. Date: Dec. 23, 2010

(54) SYSTEM AND METHOD FOR DRIVING A LIQUID CRYSTAL DISPLAY

(75) Inventors: Meng-Tse Weng, Tainan (TW); Ying-Lieh Chen, Tainan (TW); Chien-Ru Chen, Tainan (TW)

Correspondence Address: BAKER & MCKENZIE LLP;PATENT DEPARTMENT, 2001 ROSS AVENUE, SUITE 2300, DALLAS, TX, 75201, US

(73) Assignee: HIMAX TECHNOLOGIES LIMITED, Tainan (TW)

(21) Appl. No.: 12/490,255

(22) Filed: Jun. 23, 2009

(51) Int. Cl. G09G 5/10

(52) U.S. Cl. 345/690; 345/89; 345/99

(57) ABSTRACT

The invention describes a system and method for driving a display device that includes an array of pixels respectively coupled with a plurality of scanning lines along a first direction and a plurality of data lines along a second direction, each of the data lines being adapted to transmit a driving signal that is amplified in a high-driving mode of operation. In one embodiment, the method comprises reading digital data associated with each of a plurality of pixels along one or more scanning line, evaluating a distribution of gray scale levels for pixels coupled along the one or more scanning line based on the content of the digital data, and determining whether the distribution of gray scale levels meets a condition for generating a control signal to disable the high-driving mode of operation.

### FIELD OF THE INVENTION

The invention generally relates to liquid crystal displays, and more particularly to a system and method for driving a liquid crystal display.

### DESCRIPTION OF THE RELATED ART

Conventionally, a liquid crystal display comprises a liquid crystal panel and a driver circuit coupled with the liquid crystal panel. The liquid crystal panel usually includes two substrates having opposite electrodes, a liquid crystal layer confined between the two substrates, and polarizer layers attached to outer surfaces of the two substrates. Light transmittance through the liquid crystal display panel is controlled by applying voltages to the electrodes, which generate an electric field across the liquid crystal layer to rearrange the liquid crystal molecules. A plurality of switching devices, such as thin film transistors (TFT), are connected with the pixel electrodes on one of the substrates for adequately switching and applying driving voltages applied by the driver circuit.

The driver circuit generally includes scanning drivers, data drivers, and a timing controller that issues various control signals and digital display data to the scanning and data drivers. The data drivers receive the digital display data, convert them into driving voltages corresponding to gray scale levels associated with the pixels, and then outputs the driving voltages through data lines. For large display panels, the conventional data drivers may also be adapted to work in a high-driving mode of operation, whereby driving voltages may be amplified through an amplifier circuit before they are outputted through the data lines to the TFTs. While the high-driving mode of operation may exhibit enhanced output slew rates, it is not without some downside effects. First, the driver circuit when operating in the high-driving mode consumes more power. In addition, the driven pixels may be subjected to a higher temperature stress as a result of higher driving signals.

Therefore, there is a need for a system that can drive a liquid crystal display in a more flexible manner and overcome at least the foregoing issues.

### SUMMARY OF THE INVENTION

The application describes a system and method for driving a liquid crystal display. In one embodiment, the method comprises reading digital data associated with each of a plurality of pixels along one or more scanning line, evaluating a distribution of gray scale levels for pixels coupled along the one or more scanning line based on the content of the digital data, and determining whether the distribution of gray scale levels meets a condition for generating a control signal to disable a high-driving mode of operation.

In another embodiment, a display device is described. The display device comprises a display panel including an array of pixels, and a driver unit including at least one scan driver, one data driver, and a control module. The scan driver is coupled with the array of pixels through a plurality of scanning lines. The data driver is coupled with the array of pixels through a plurality of data lines, and is adapted to output display signals through the data lines based on digital data associated with each of the pixels, the display signals being amplified in a high-driving mode of operation. The control module is configured to determine whether a distribution of gray scale levels for pixels coupled along one or more scanning line meets a condition for generating a control signal to disable the high-driving mode of operation.

At least one advantage of the systems and methods described herein is the ability to control the high-driving mode of operation of the data driver in a more flexible manner, based on the evaluation of the distribution of gray scale levels associated with pixels driven by the driver unit. As a result, power consumption and temperature stress on the pixels can be reduced.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1 is a schematic diagram of a liquid crystal display according to one embodiment of the invention;

FIG. 2A is a schematic diagram of a data driver coupled with a high-driving control module according to one embodiment of the present invention;

FIG. 2B is a schematic diagram of a data driver coupled with a high-driving control module according to another embodiment of the present invention;

FIG. 3 is a flowchart of method steps performed by a high-driving control module for evaluating a distribution of gray scale levels, according to one embodiment of the present invention;

FIG. 4 is a flowchart of method steps performed by a high-driving control module for determining whether the distribution of gray scale levels meets one or more condition for disabling the high-driving mode of operation; and

FIG. 5 is a block diagram of a driver unit configured to selectively disable a high-driving mode of operation, according to another embodiment of the present invention.

### DETAILED DESCRIPTION OF THE EMBODIMENTS

The present application describes a system and method for driving a liquid crystal display. In one embodiment, the liquid crystal display comprises an array of pixels adapted to display an image based on control and driving signals provided by a driver unit. The driver unit includes a timing controller for receiving digital display data from a host device, at least one scan driver (also commonly called “gate driver” or “gate line driver”) that is coupled with multiple scanning lines (also commonly called “gate lines”) in the array of pixels, and a data driver (also commonly called “source driver” or “source line driver”) coupled with multiple data lines (also commonly called “source lines”) in the array of pixels. The data driver is adapted to output driving signals that are amplified in a high-driving mode of operation. The driver unit is configured to evaluate in real-time a distribution of gray scale levels for pixels along one or more scanning lines based on the display data, and determine whether the distribution of gray scale levels meet a condition for disabling the high-driving mode of operation. Power consumption and pixel thermal stress can thereby be reduced.

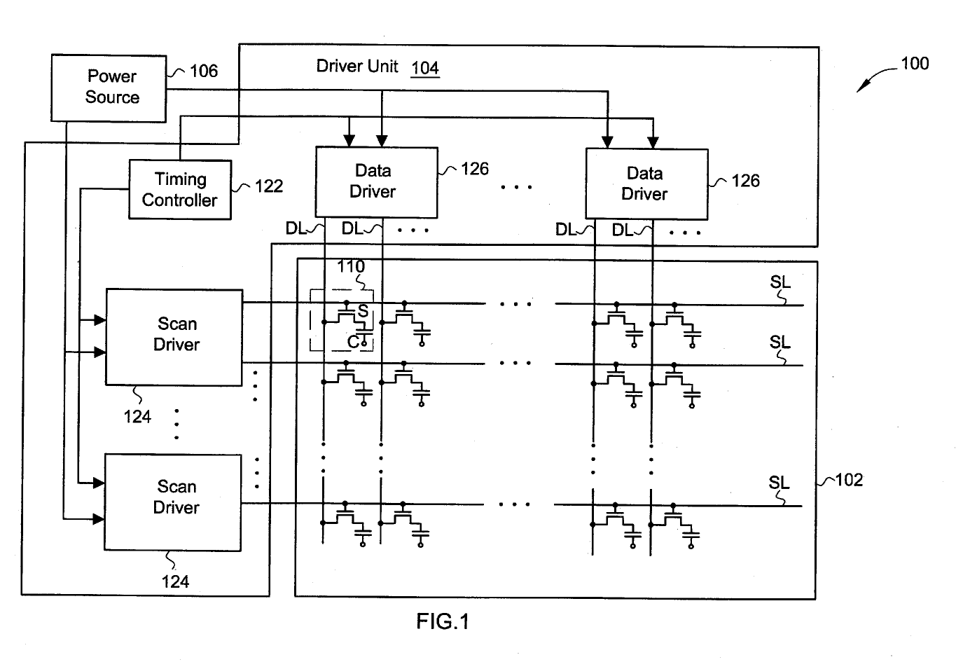

FIG. 1 is a schematic diagram of a liquid crystal display 100 according to one embodiment of the present invention. The liquid crystal display 100 includes a display panel 102, a driver unit 104, and a power source 106. The display panel 102 may be a reflective type, transmissive type, or transflective type liquid crystal display panel. The display panel 102 comprises an array of pixels 110 operable under control of the driver unit 104 for displaying an image. Each pixel 110 of the display panel 102 may include a switching element S, such as a thin-film transistor (TFT), which is coupled with a storage capacitor C and one or more pixel electrode (not shown). The driver unit 104, powered by the power source 106, includes a timing controller 122, one or more scan driver 124, and one or more data driver 126. The timing controller 122 receives digital display data from a host device (not shown), generates control signals for the scan drivers 124 and data drivers 126, and transmit the digital display data to the data drivers 126. The host device may include a computer graphics card, a computer central processing unit (CPU), a television adapter, or like display data sources. Each scan driver 124 is coupled with horizontal rows of pixels 110 through multiple scanning lines SL, and each data driver 126 is coupled with vertical columns of pixels 110 through multiple data lines DL. Each of the scan drivers 124 and data drivers 126 may be built from an integrated circuit (IC) chip that may be mounted on the display panel 102 according to various methods, such as through tape carrier packages (TCP), chip-on-glass (COG) technology, or the like. In alternate embodiments not shown, either of the scan or data drivers may also be integrated into a single IC chip.

During one horizontal synchronizing period, one scan driver 124 turns on the TFTs coupled along one selected scanning line SL, whereas each of the data drivers 126 applies driving signals through the data lines DL onto the turned-on TFTs to charge the associated capacitors C with display voltages corresponding to gray scale levels. Owing to a voltage difference between a common electrode (not shown) and the display electrodes applied with the display voltages latched by the storage capacitors C, liquid crystal molecules (not shown) in the display panel 102 are controllably oriented to achieve a desired light transmittance. Each horizontal row of pixels 110 is sequentially driven in this manner for displaying an image frame.

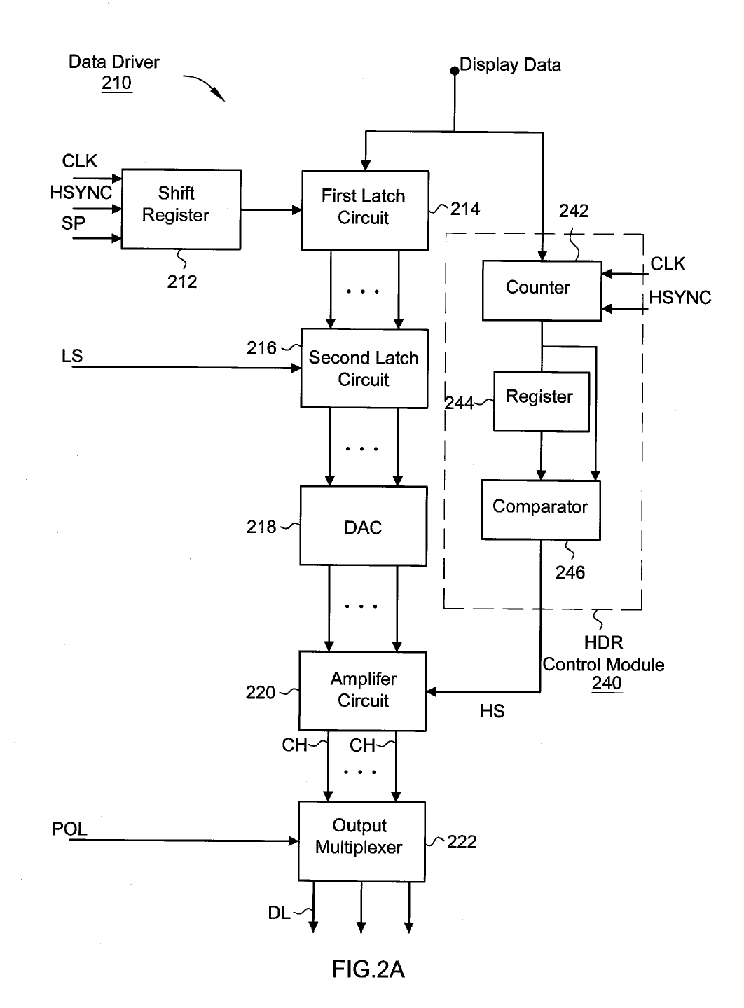

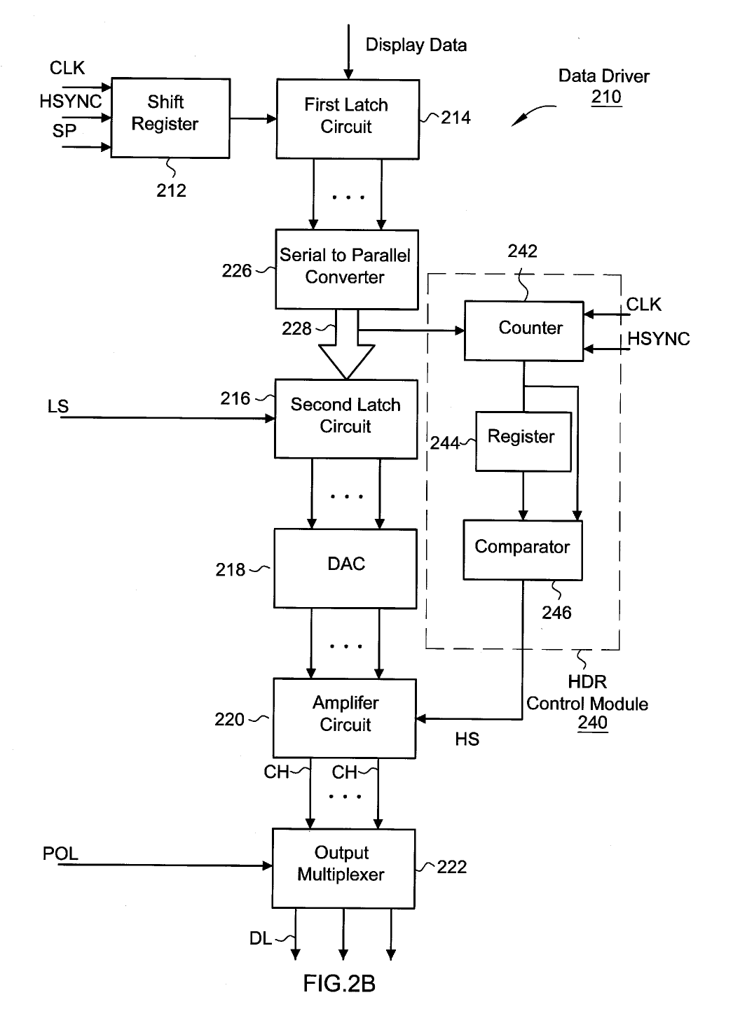

FIG. 2A is a schematic diagram of a data driver 210 according to one embodiment of the present invention. The data driver 210 comprises a shift register 212, first and second latch circuit 214 and 216, a digital-to-analog converter (DAC) 218, an amplifier circuit 220, and an output multiplexer 222. The shift register 212 receives a clock signal (CLK), a horizontal synchronizing signal (HSYNC) and a start pulse (SP) from the timing controller (FIG. 1), and sequentially outputs sampling pulses to the first latch circuit 214 at prescribed timings. The first latch circuit 214 sequentially samples digital display data transmitted from the timing controller in synchronization with the sampling pulses, and holds these digital display data during one horizontal sampling period. The digital display data may include color values, each corresponding to a gray scale level of a pixel, that are defined in a given color system such as the red (R), green (G) and blue (B) color system. In synchronization with a latch signal (LS), the second latch circuit 216 receives and latches in one time all the digital display data sampled in the first latch circuit 214. The digital display data held in the second latch circuit 216 may undergo amplitude modulation via a level shift circuit (not shown) before being processed through the DAC 218. The DAC 218 converts the digital display data into selected analog driving voltage signals corresponding to gray scale levels associated with the driven pixels. The amplifier circuit 220 comprises a plurality of operational amplifiers that may be selectively enabled in a high-driving mode of operation. When the high-driving mode of operation is enabled, the amplifier circuit 220 amplifies the driving voltage signals, which are then transmitted through output channels CH to the output multiplexer 222. The output multiplexer 222 selectively connects each of the output channels CH with either an odd-numbered or even-numbered data line DL based on a polarity control signal POL provided by the timing controller. In one embodiment, the polarity control signal POL may be configured to set alternated polarity of the driving voltage signals along the data lines DL, such as in a dot-inverted driving mode.

The high-driving mode of operation of the amplifier circuit 220 may be enabled or disabled according to a control signal HS transmitted by a high-driving (HDR) control module 240 to the amplifier circuit 220. In each horizontal synchronizing period, the HDR control module 240 reads digital display data inputted to the data driver 210 for a number of pixels coupled along one scanning line in synchronization with the horizontal synchronizing signal HSYNC, evaluates a distribution of gray scale levels from the display data, and determines whether the distribution of gray scale levels matches with one or more condition for generating a control signal to disable the amplifier circuit 220. The HDR control module 240 may be either integrated within the data driver 210, or provided separately.

As shown in FIG. 2A, one embodiment of the HDR control module 240 may comprise a counter 242, at least one register 244, and a comparator 246. The counter 242 receives a clock signal CLK and horizontal synchronizing signal HSYNC, and tracks the occurrences of gray scale levels that are within one or more range of values from digital display data received by the data driver 210 in one horizontal synchronizing period. More specifically, in one embodiment, the counter 242 may be configured to detect gray scale levels that are in a higher range of gray scale values relative to a median gray scale value by, for example, reading digital display data inputted to the first latch circuit 214 that have a most superior bit (MSB) equal to the binary value “1”. In alternate embodiments, the occurrences of gray scale levels in a lower range below the median gray scale value may also be tracked by reading display data that have a MSB set to the binary value “0”. Based on the counted occurrences, a distribution of gray scale levels can be estimated for pixels updated by the data driver 210 during one horizontal synchronizing period. A person skilled in the art will readily appreciate that the above higher and lower ranges of gray scale values have been described for the only purpose of illustration, and other ranges of gray scale values may also be chosen for evaluating the distribution of gray scale levels.

The register 244 is configured to store the counted occurrences of gray scale levels tracked by the counter 242 for one or more successive scanning line. The comparator 246 compares the counted occurrences against a threshold value for determining whether one or more conditions for generating a control signal to disable (or enable) the amplifier circuit 220 is met. If the condition(s) set in the comparator 246 is satisfied, the comparator 246 sends a control signal HS to the amplifier circuit 220 to disable (or enable) the high-driving mode of operation. Consequently, driving voltage signals may be outputted through the output channels CH without amplification.

While FIG. 2A illustrates an embodiment in which the HDR control module 240 may access the digital display data from the input of the first latch circuit 214, other configurations are possible. For example, in another embodiment shown in FIG. 2B, the digital display data read by the counter 242 may also be accessed from a data bus 228 at the output of a serial-to-parallel converter 226 coupled between the first latch circuit 214 and second latch circuit 216. This may be achieved by connecting the data input of the HDR control module 240 to the data bus 228 that transfers digital display data between the serial-to-parallel converter 226 and the second latch circuit 216.

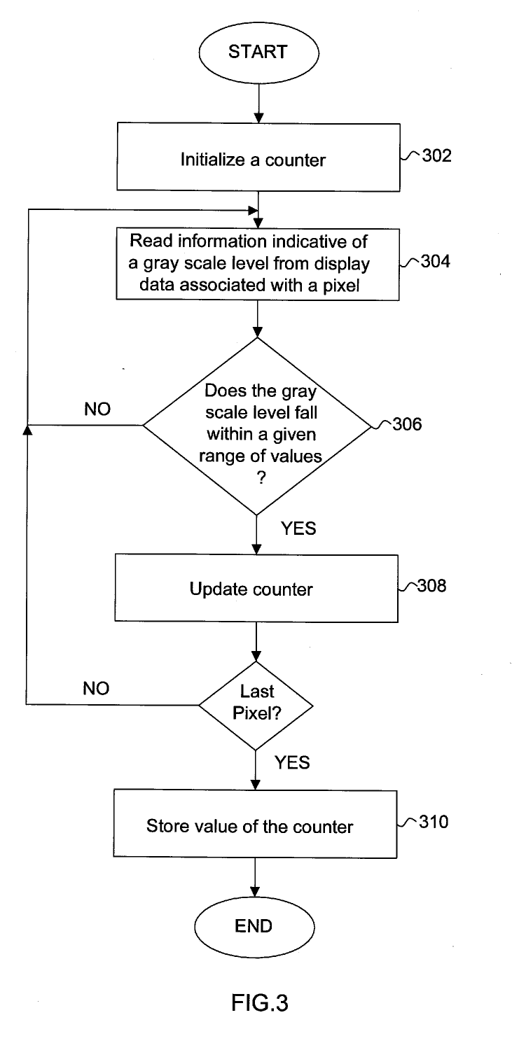

FIG. 3 is a flowchart of method steps performed by the HDR control module 240 for evaluating a distribution of gray scale levels, according to one embodiment of the present invention. In initial step 302, the counter 242 is reset as it receives an initialization signal (such as horizontal synchronizing signal HSYNC) indicating that digital display data associated with pixels of one selected scanning line are to be transmitted through the data driver 210. In step 304, information indicative of a gray scale level is then read from digital display data associated with a pixel of the selected scanning line in synchronization with the clock signal CLK. As described previously, the digital display data may be accessed either from the input of the first latch circuit 214 or the data bus 228 between the serial-to-parallel converter 226 and the second latch circuit 216. In step 306, it is then determined whether the gray scale level falls within a predetermined range of values. In one embodiment, the predetermined range of values may be a higher (or lower) range of values relative to a median gray scale value. For example, step 306 may be performed by determining whether the MSB of the digital display data is equal to the binary value “1” (or “0”). If the MSB is equal to 1, it can be deduced that the gray scale level is at least in the higher range of values. Accordingly, in next step 308, the counter 242 is incremented by one. If the MSB is not equal to 1 (i.e., equal to 0), it can be deduced that the gray scale level is in the lower range of values relative to the median gray scale value, in which case the counter 242 is not incremented. Steps 304 through 308 are repeatedly performed for all digital display data received by the data driver 210 during one horizontal synchronizing period. Eventually, in step 310, the number of occurrences of gray scale levels tracked by the counter 242 for the selected scanning line is stored in the register 244. The method steps 302 through 310 may then be repeated again to evaluate a distribution of gray scale levels for pixels of a next selected scanning line.

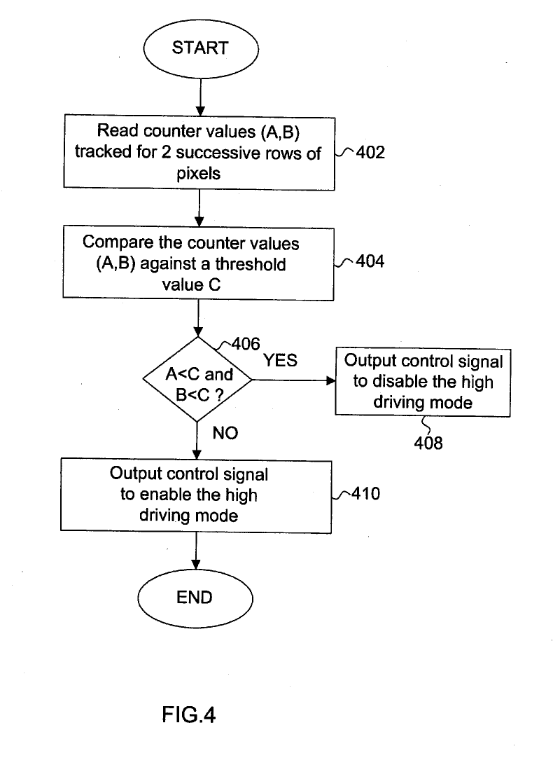

FIG. 4 is a flowchart of method steps performed by the HDR control module 240 for determining whether the distribution of gray scale levels meets one or more condition for disabling the high-driving mode of operation, according to one embodiment of the present invention. In initial step 402, the comparator 246 reads two counter values (A, B) respectively tracked by the counter 242 for pixels coupled along two successive scanning lines. As described previously, the counter values (A, B) are measures of the distribution of gray scale levels associated with pixels that are coupled along the two successive scanning lines. Either of the counter values (A, B) may be read from the register 244 or directly from the counter 242. In step 404, the comparator 246 then compares each of the counter values (A, B) against a threshold value C. In one embodiment, the threshold value C may be derived from the number of output channels CH of the amplifier circuit 220, e.g., C may be equal to the number of output channels divided by two. If the comparator 246 in step 406 finds that the counter values A and B are both less than the threshold value C (i.e., A<C and B<C), step 408 is subsequently performed to output a control signal HS that disables the high-driving mode of operation. Driving voltage signals provided by the DAC 218 may be consequently transmitted through the disabled amplifier circuit 220 to the output channels CH without amplification.

On the other hand, if the condition (A<C and B<C) in step 406 is not satisfied, step 410 is performed to output a control signal HS that enables the high-driving mode of operation. The condition (A<C and B<C) may not be satisfied when the counted occurrences of gray scale levels for at least one of the two successive scanning lines (i.e., either A or B) is greater than the threshold value C. Accordingly, driving voltage signals provided by the DAC 218 may be amplified through the enabled amplifier circuit 220, and then outputted through the output channels CH to the output multiplexer 222.

It is worth noting that the aforementioned conditions have been described as examples, and alternate embodiments may set other conditions more or less restrictive for determining whether to disable or enable the high-driving mode according to the actual distribution of gray scale levels (i.e., occurrences of gray scale levels that are of higher or lower values). As a result, the high-driving mode of operation of the data driver can be controlled in a more flexible manner, depending on whether a higher number of occurrences of higher gray scale levels are detected.

While the aforementioned description illustrate embodiments where the HDR control module is coupled with one data driver, other configurations may also be suitable. For example, in alternate embodiments, the HDR control module may also be coupled with the timing controller as described below.

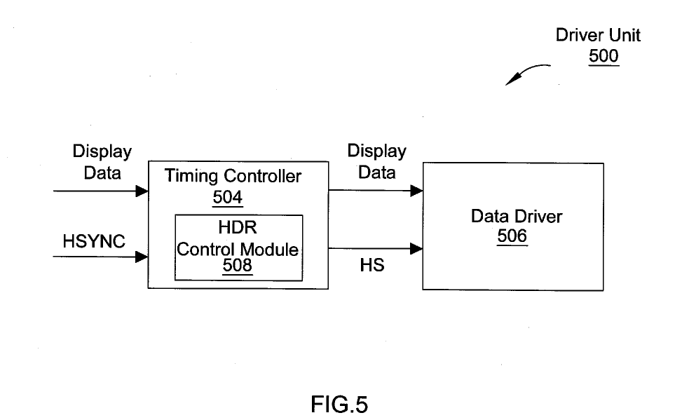

FIG. 5 is a block diagram of a driver unit 500 configured to selectively disable a high-driving mode of operation, according to another embodiment of the present invention. The driver unit 500 comprises a timing controller 504 and a data driver 506. Other elements that may be present in the driver unit 500 have been omitted for the sake of clarity. The timing controller 504 receives a horizontal synchronizing signal (HSYNC) and digital display data from a host device (not shown), and transmits control signals and the digital display data to the data driver 506. In the illustrated embodiment, the timing controller 504 also comprises a HDR control module 508. Embodiments and operation of the HDR control module 508 have been described previously. Coupled with the HDR control module 508, the timing controller 504 is able to issue a control signal HS to the data driver 506 for selectively enabling or disabling its high-driving mode of operation. The control signal HS may be outputted either through a separate signal interface or included in the data packets sent to the data driver 506. Examples of adequate signaling interfaces for transmitting the control signal HS may include a Reduced Swing Differential Signaling (RSDS) interface, Low Voltage Differential Signaling (LVDS) interface, or the like.

The above-described systems and methods are therefore able to control the high-driving mode of operation of the data driver in a more flexible manner by evaluating the distribution of gray scale levels from the content of digital display data received by the data driver. As a result, power consumption and temperature stress on the driven pixels can be reduced.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the invention as defined in the claims that follow.

What is claimed is:

1. A method for driving a display device that includes an array of pixels respectively coupled with a plurality of scanning lines along a first direction and a plurality of data lines along a second direction, each of the data lines being adapted to transmit a driving signal that is amplified in a high-driving mode of operation, the method comprising:
reading digital data associated with each of a plurality of pixels along one or more scanning line;
evaluating a distribution of gray scale levels for pixels coupled along the one or more scanning line based on the content of the digital data; and
determining whether the distribution of gray scale levels meets a condition for generating a control signal to disable the high-driving mode of operation.

2. The method according to claim 1, wherein the step of evaluating a distribution of gray scale levels comprises counting occurrences of gray scale levels that are within a range of values along one scanning line.

3. The method according to claim 2, wherein the step of counting occurrences of gray scale levels that are within a range of values along one scanning line is initialized at each horizontal synchronizing signal.

4. The method according to claim 2, wherein the step of counting occurrences of gray scale levels that are within a range of values comprises reading a most superior bit of the digital data associated with each pixel.

5. The method according to claim 2, wherein the step of determining whether the distribution of gray scale levels meets a condition for generating a control signal to disable the high-driving mode of operation comprises comparing the counted occurrences against a threshold value.

6. The method according to claim 5, wherein the threshold value is derived from a total number of output channels of a data driver coupled with the data lines.

7. The method according to claim 5, wherein one condition for generating a control signal to disable the high-driving mode of operation is met when the counted occurrences along at least two successive scanning lines are respectively less than the threshold value.

8. The method according to claim 7, further comprising generating a second control signal for enabling the high-driving mode of operation when the counted occurrences along at least one of two successive scanning lines is greater than the threshold value.

9. A display device comprising:
a display panel including an array of pixels; and
a driver unit including:
at least one scan driver coupled with the array of pixels through a plurality of scanning lines;
at least one data driver coupled with the array of pixels through a plurality of data lines, wherein the data driver is adapted to output driving signals through the data lines based on digital data associated with each of the pixels, the driving signals being amplified in a high-driving mode of operation; and
a control module configured to determine whether a distribution of gray scale levels for pixels coupled along one or more scanning line meets a condition for generating a control signal to disable the high-driving mode of operation.

10. The display device according to claim 9, wherein the control module is configured to evaluate the distribution of gray scale levels from digital data associated with each pixel along the one or more scanning line.

11. The display device according to claim 10, wherein the driver unit further comprises a timing controller coupled with the data driver, the control module being configured to evaluate the distribution of gray scale levels from digital data received in the timing controller.

12. The display device according to claim 10, wherein the control module is configured to evaluate a distribution of gray scale levels from digital data transmitted to a first latch circuit in the data driver.

13. The display device according to claim 10, wherein the control module is configured to evaluate a distribution of gray scale levels from digital data transmitted through a data bus between a serial-to-parallel converter and a second latch circuit in the at least one data driver.

14. The display device according to claim 10, wherein the control module is configured to evaluate the distribution of gray scale levels by counting occurrences of gray scale levels that are within a range of values along one scanning line.

15. The display device according to claim 14, wherein the control module is configured to initialize a count of occurrences of gray scale levels that are within a range of values at each horizontal synchronizing signal.

16. The display device according to claim 14, wherein the range of values corresponds to digital data having a most superior bit equal to a same binary value.

17. The display device according to claim 14, wherein the control module is configured to determine whether a distribution of gray scale levels meets a condition for generating a control signal to disable the high-driving mode of operation by comparing the counted occurrences against a threshold value.

18. The display device according to claim 17, wherein the threshold value is derived from a total number of output channels of the at least one data driver.

19. The display device according to claim 17, wherein one condition for generating a control signal to disable the high-driving mode of operation is met when the counted occurrences along at least two successive scanning lines are respectively less than the threshold value.

20. The display device according to claim 19, wherein the control module is further configured to generate a second control signal for enabling the high-driving mode of operation when the counted occurrences along at least one of two successive scanning lines is greater than the threshold value.
